(19) United States
(12) Patent Application Publication
(10) Pub. No.: US 2025/0201883 A1
(43) Pub. Date: Jun. 19, 2025

(54) MEMBRANE-ELECTRODE ASSEMBLY PROCESSING APPARATUS, MEMBRANE-ELECTRODE ASSEMBLY MANUFACTURING APPARATUS, AND MEMBRANE-ELECTRODE ASSEMBLY

(71) Applicants: Hyundai Motor Company, Seoul (KR); Kia Corporation, Seoul (KR)

(72) Inventor: Min Jin Kim, Seoul (KR)

(21) Appl. No.: 18/609,309

(22) Filed: Mar. 19, 2024

(30) Foreign Application Priority Data
Dec. 19, 2023 (KR) 10-2023-0185663

(51) Int. Cl. H01M 8/1004

(52) U.S. Cl. CPC H01M 8/1004

(57) ABSTRACT

A membrane electrode assembly processing apparatus and a membrane electrode assembly manufacturing apparatus may include a composite punching roller configured to punch out a membrane electrode assembly unit from a membrane electrode assembly continuous film including at least one membrane electrode assembly unit and to apply an adhesive to an outer peripheral area of an electrode layer of the membrane electrode assembly unit.

### CROSS-REFERENCE TO RELATED APPLICATIONS

This application claims the benefit of Korean Patent Application No. 10-2023-0185663 filed on Dec. 19, 2023, the entire contents of which are incorporated herein by reference.

### TECHNICAL FIELD

The present disclosure relates to a membrane electrode assembly manufacturing apparatus.

### BACKGROUND

A membrane electrode assembly (MEA), i.e., an assembly of electrodes and an electrolyte membrane of a fuel cell, may include a structure shown in FIG. 1A. Subgaskets are bonded to the MEA to provide stiffness to the MEA and to form inlets for fluids, such as fuel and coolant, as shown in FIG. 1B. FIGS. 1C and 1D show other examples. Various attempts to reduce the electrolyte membrane have been made. Bubbles may be formed between an adhesive or the subgaskets and the MEA and may cause defects, or there may be a risk that the appearance of the MEA may be changed due to inflow and expansion of produced water due to formation of voids in stepped areas.

Therefore, a need exists to design a continuous MEA processing apparatus and manufacturing apparatus that may suppress occurrence of these problems and minimize waste of an adhesive and an electrolyte membrane.

The above information disclosed in this Background section is only for enhancement of understanding of the background of the disclosure and therefore it may contain information that does not form the prior art that is already publicly known or in public use.

### SUMMARY

The present disclosure relates to a membrane electrode assembly processing apparatus, a membrane electrode assembly manufacturing apparatus, and a membrane electrode assembly.

Some embodiments of the present disclosure can solve the above-described problems associated with the prior art, and an embodiment of the present disclosure can provide an apparatus for processing a membrane electrode assembly partially coated with an adhesive, an apparatus for bonding a subgasket to the membrane electrode assembly therethrough, and a membrane electrode assembly manufacturing apparatus that may enable mass production of membrane electrode assemblies while securing durability and high quality of the membrane electrode assemblies.

Advantages of the present disclosure are not necessarily limited to the above-mentioned advantages. Advantages of the present disclosure can become clearer from the following description, and may be realized by various embodiments and combinations thereof.

In an embodiment of the present disclosure, a membrane electrode assembly processing apparatus includes a composite punching roller configured to punch out a membrane electrode assembly unit from an MEA continuous film including at least one membrane electrode assembly unit in a transfer direction and to apply an adhesive to an outer peripheral area of an electrode layer of the membrane electrode assembly unit.

In an embodiment of the present disclosure, a membrane electrode assembly manufacturing apparatus includes a composite punching roller configured to punch out a membrane electrode assembly unit from an MEA continuous film including at least one membrane electrode assembly unit in a transfer direction and to apply an adhesive to an outer peripheral area of an electrode layer of the membrane electrode assembly unit, a punching roller configured to punch an subgasket (SG) continuous film including a subgasket at selected, set, or predetermined intervals to form penetration parts, a heating roller positioned behind (at a later stage of) the punching roller and configured to heat the SG continuous film, and a control roller positioned behind (at a later stage of) the composite punching roller and configured to approach the heating roller to engage therewith and to transfer the membrane electrode assembly unit to an outer peripheral area of one of the penetration parts of the SG continuous film.

In an embodiment of the present disclosure, a membrane electrode assembly includes an electrolyte membrane, electrode layers placed on both surfaces of the electrolyte membrane, an adhesive provided to have a designated width inwards and/or outwards from an outer periphery of a surface of at least one of the electrode layers, and a subgasket placed on the adhesive.

### BRIEF DESCRIPTION OF THE DRAWINGS

The above and other features of the present disclosure will now be described in detail with reference to certain example embodiments thereof illustrated in the accompanying drawings, which are given hereinbelow by way of illustration only, and thus are not necessarily limitative of the present disclosure, and in which:

In FIG. 1A is a schematic diagram showing an example of a membrane electrode assembly;

In FIGS. 1B to 1D are schematic diagrams showing various examples of bonding of an adhesive and subgaskets to the membrane electrode assembly;

In FIGS. 2A and 2B are schematic diagrams showing various examples of bonding of an adhesive and a subgasket to a part of a membrane electrode assembly in accordance with an embodiment of the present disclosure;

FIG. 3 is a schematic diagram showing an example of a membrane electrode assembly manufacturing apparatus according to an embodiment of the present disclosure;

FIG. 4 is a schematic diagram showing a punching unit of a composite punching roller used in a membrane electrode assembly processing apparatus and the membrane electrode assembly manufacturing apparatus according to an embodiment of the present disclosure;

In FIGS. 5A to 5D are schematic diagrams sequentially showing an example of a process of punching out a membrane electrode assembly unit from an MEA continuous film using the composite punching roller and applying an adhesive in the membrane electrode assembly processing apparatus according to an embodiment of the present disclosure;

FIG. 6 is a schematic diagram showing that membrane electrode assembly units obtained by the membrane electrode assembly manufacturing apparatus according to an embodiment of the present disclosure are transferred to penetration parts of an SG continuous film;

In FIGS. 7A to 7C are schematic diagrams showing examples of composite punching rollers provided in the membrane electrode assembly processing apparatus and the membrane electrode assembly manufacturing apparatus according to an embodiment of the present disclosure;

FIG. 8 is a schematic diagram showing an example of a membrane electrode assembly manufactured by the membrane electrode assembly manufacturing apparatus according to an embodiment of the present disclosure; and

FIG. 9 is a schematic diagram showing another example of the membrane electrode assembly manufactured by the membrane electrode assembly manufacturing apparatus according to an embodiment of the present disclosure.

It can be understood that the appended drawings are not necessarily to scale, presenting a somewhat simplified representation of various features illustrative of the basic principles of an embodiment of the present disclosure. Specific design features of embodiments of the present disclosure as disclosed herein, including, for example, specific dimensions, orientations, locations, and shapes, can be determined in part by the particular intended application and use environment, for example.

In the figures, reference numbers can refer to the same or equivalent parts of embodiments of the present disclosure throughout the several figures of the drawing.

### DETAILED DESCRIPTION OF ILLUSTRATIVE EMBODIMENTS

The above-described advantages and features of the present disclosure can become apparent from the descriptions of embodiments given hereinbelow with reference to the accompanying drawings. However, the present disclosure is not necessarily limited to the embodiments disclosed herein and may be implemented in various different forms. The embodiments are provided to make the description of the present disclosure thorough and to fully convey scope of the present disclosure to those skilled in the art.

In the drawings, same or similar elements can be denoted by same reference numerals even though they can be depicted in different drawings. In the accompanying drawings, the dimensions of structures may be exaggerated compared to the actual dimensions thereof, for clarity of description. In the following description of some embodiments, terms, such as “first” and “second”, may be used to describe various elements but do not necessarily limit the elements. Such terms can be used merely to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including”, “comprising”, and “having”, are to be interpreted as indicating the presence of characteristics, numbers, steps, operations, elements, or parts stated in the description, or combinations thereof, and do not exclude the presence of one or more other characteristics, numbers, steps, operations, elements, parts, or combinations thereof, or possibility of adding the same. In addition, it can be understood that, when a part, such as a layer, a film, a region, or a plate, is said to be “on” another part, the part may be located “directly on” the other part or other parts may be interposed between the two parts. In the same manner, it can be understood that, when a part, such as a layer, a film, a region, or a plate, is said to be “under” another part, the part may be located “directly under” the other part or other parts may be interposed between the two parts.

All numbers, values, and/or expressions representing amounts of components, reaction conditions, polymer compositions, and blends used in the description can be approximations in which various uncertainties in measurement generated when these values can be obtained from essentially different things are reflected and thus it will be understood that they can be modified by the term “about”, unless stated otherwise. In addition, it can be understood that, if a numerical range is disclosed in the description, such a range can include all continuous values from a minimum value to a maximum value of the range, unless stated otherwise. Further, if such a range refers to integers, the range can include all integers from a minimum integer to a maximum integer, unless stated otherwise.

To implement a membrane electrode assembly structure shown in FIG. 2B, a method of bonding a subgasket to one membrane electrode assembly may be applied, according to an embodiment. Such method can be a discontinuous method and thus can have a limit in increase in a mass production speed unlike a roll-to-roll process, and may have difficulty in handling one stack structure due to the nature of a subgasket material and may thus cause many defects.

In accordance with an embodiment of the present disclosure, a membrane electrode assembly processing apparatus and a membrane electrode assembly manufacturing apparatus may perform punching-out of a membrane electrode assembly unit from an MEA continuous film including a plurality of membrane electrode assembly units and application of an adhesive to a designated area of the membrane electrode assembly unit, simultaneously, and may apply the adhesive exactly where it is needed/specified.

### Membrane Electrode Assembly Processing Apparatus

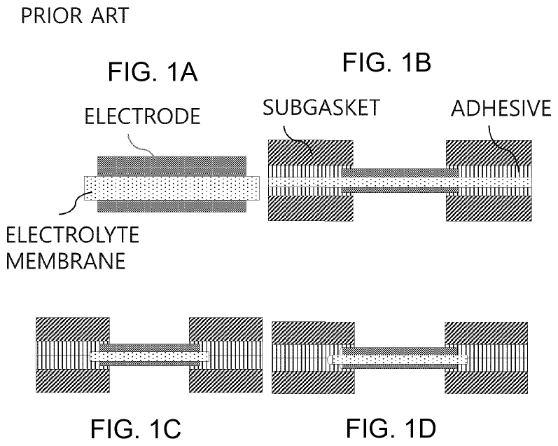

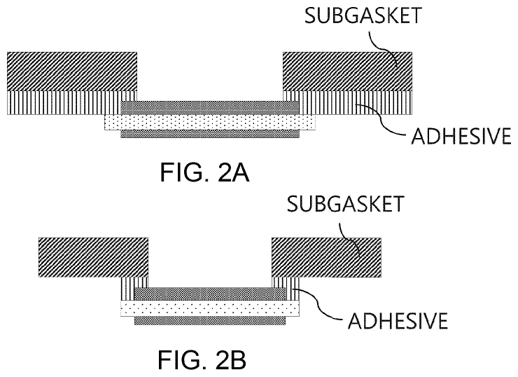

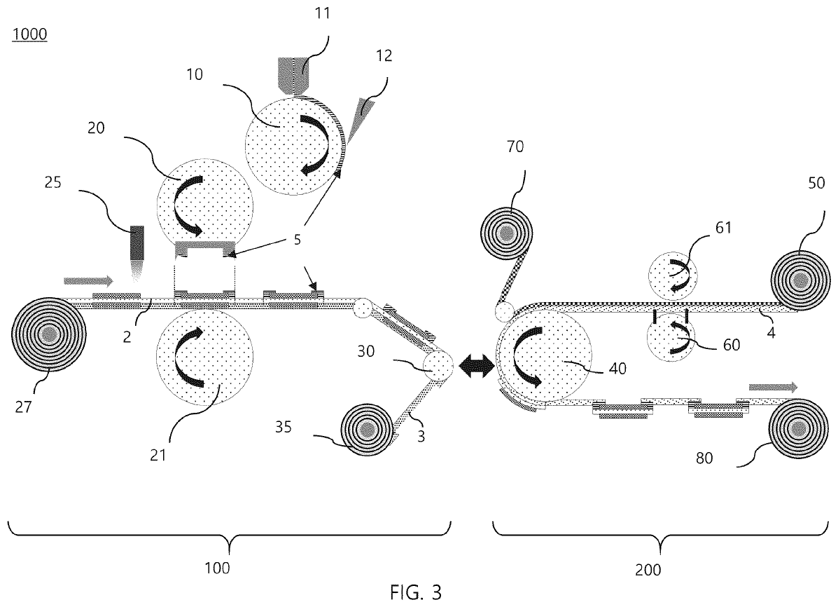

Referring to FIGS. 3 to 5D and FIGS. 7A to 7C, a membrane electrode assembly processing apparatus 100 according to an embodiment of the present disclosure may include a composite punching roller 20 configured to punch out a membrane electrode assembly unit from an MEA continuous film 2 including at least one membrane electrode assembly unit in a transfer direction and to apply an adhesive 5 to the outer peripheral area of an electrode layer of the membrane electrode assembly unit.

The membrane electrode assembly processing apparatus 100 may further include an auxiliary roller 21 at a position opposite to the composite punching roller 20 with the MEA continuous film 2 interposed therebetween. The auxiliary roller 21 may assist in transfer of the MEA continuous film 2, and may control balance of the MEA continuous film 2 when the punching process is performed by the composite punching roller 20.

The adhesive 5 in the outer peripheral area of the surface of the electrode layer of the membrane electrode assembly unit may have a designated width inwards and/or outwards from the outer periphery of the surface of the electrode layer of the membrane electrode assembly unit, and the width in the inward direction and the width in the outward direction may be the same or different. As an example, the adhesive 5 may be formed to surround the outer periphery of the electrode layer and to extend to a portion of a region inside the periphery, and may have a ring shape corresponding to the shape of the periphery of the electrode layer, or a ring shape including some discontinuous portions. The width of the outer peripheral area may be adjusted depending of the size of the membrane electrode assembly unit, and may be 0.01 to 0.4 times the maximum length of the membrane electrode assembly unit, for example. By having such width, a subgasket may be easily bonded to the outer peripheral area where the adhesive 5 is applied through a subsequent apparatus.

The MEA continuous film 2 may be unwound and supplied from an MEA continuous film supplier 27, and the MEA continuous film 2 can have membrane electrode assembly units provided at regular intervals in the longitudinal direction of the MEA continuous film 2.

The MEA continuous film 2 may include a carrier film 3 adhered thereto in a direction opposite to the direction in which the adhesive 5 is applied, and the composite punching roller 20 may punch out the membrane electrode assembly unit except for the carrier film 3. Thereby, the membrane electrode assembly unit on the carrier film 3 may be easily transferred to an SG continuous film 4 through an apparatus which will be described later.

The carrier film 3 may include a pressure-sensitive adhesive on one side thereof that contacts the MEA continuous film 2. Peeling force between the carrier film 3 and the MEA continuous film 2 may be 1 N/25 mm to 10 N/25 mm, for example. When the peeling force is less than 1 N/25 mm, there can be a risk that MEA continuous film 2 may be easily separated from the carrier film 3, and when the peeling force exceeds 10 N/25 mm, it can be difficult to transfer the membrane electrode assembly unit to another film, and thus, the membrane electrode assembly unit may be damaged. For example, the pressure-sensitive adhesive may include an acrylic material, a silicone-based material, styrene-butadiene rubber, or the like, for example.

The carrier film 3 may include a polymer film, such as polyethylene terephthalate, polyimide, or polyethylene naphthalate, for example.

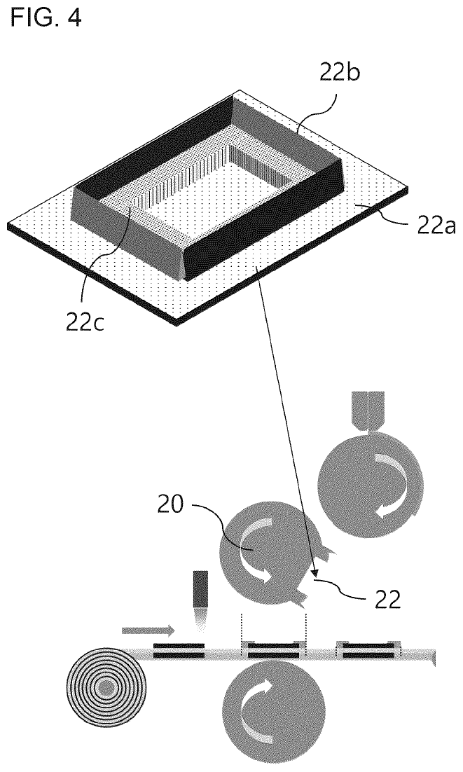

Referring to FIG. 4, the composite punching roller 20 may include at least one punching unit 22 provided on the outer circumferential surface thereof, the punching unit 22 may include a flat punching plate 22a, a punching blade 22b on the punching plate 22a to correspond to the perimeter of the membrane electrode assembly unit, and a stepped part 22c having a selected or designated width and thickness in the inward direction from the inner circumference of the punching blade 22b. The thickness of the stepped part 22c may be 100 μm to 10 mm based on the punching plate 22a, for example. When the thickness of the stepped part 22c is less than 100 μm, adhesive 5 can be applied to areas other than the area where the adhesive 5 should be applied, and may thus cause defects, and when the thickness of the stepped part 22c exceeds 10 mm, the stepped part 22c may be too close to an adhesive discharge roller 10 that receives the adhesive 5, and may thus be damaged.

The punching unit 22 may be attached to the composite punching roller 20 by magnetic force.

The composite punching roller 20 may be provided with two punching units 22 on the surface thereof, as shown in FIG. 7B, or may be provided with three punching units 22 on the surface thereof, as shown in FIG. 7C, or the number of punching units 22 provided on the composite punching roller 20 may be equal to greater than three but equal to or less than ten, for example.

The height of the punching blade 22b may be 110 μm to 11 mm based on the punching plate 22a, for example. When the height of the punching blade 22b is less than 110 μm, punching of the MEA continuous film 2 into the membrane electrode assembly units may not proceed effectively due to interference with the stepped part 22c, and when the height of the punching blade 22b exceeds 11 mm, the punching blade 22b may punch through the lower carrier film 3 under the MEA continuous film 2 including the membrane electrode assembly units and thus it may be difficult to transfer the MEA continuous film 2, for example. The height of the punching blade 22b may be greater than the thickness (height) of the stepped part 22c.

The width of the stepped part 22c may correspond to the width of the adhesive 5 applied to the outer peripheral area of the electrode layer.

Referring to FIG. 3, the membrane electrode assembly processing apparatus 100 may include the adhesive discharge roller 10 positioned with a gap of 100 μm to 11 mm from the composite punching roller 20, and the stepped part 22c and the punching blade 22b of the composite punching roller 20 may receive the adhesive 5 supplied from the adhesive discharge roller 10. When the gap between the composite punching roller 20 and the adhesive discharge roller 10 is less than 100 μm, the two rollers 20 and 10 can be too close to each other, which can damage of the two rollers 20 and 10 or a transfer failure of the MEA continuous film 2 may occur, and when the gap between the composite punching roller 20 and the adhesive discharge roller 10 exceeds 11 mm, the adhesive 5 supplied from the adhesive discharge roller 10 may not be moved to the composite punching roller 20, for example.

The adhesive discharge roller 10 may receive the adhesive 5, supplied from an adhesive discharger 11, on the outer circumferential surface of the adhesive discharge roller 10, and the thickness of the adhesive 5 on the adhesive discharge roller 10 may be adjusted through a separately provided leveler 12. The leveler 12 may be in the form of a blade.

Each of a gap between the adhesive discharger 11 and the adhesive discharge roller 10 and a gap between the leveler 12 and the adhesive discharge roller 10 may be 5 μm to 100 μm, for example. When the gaps are less than 5 μm, the amount of the adhesive 5 can be too small, there may be a possibility that the adhesive 5 is not smoothly moved from the adhesive discharge roller 10 to the composite punching roller 20, the thickness of the adhesive 5 finally applied to the membrane electrode assembly unit can be too small, and thus, sufficient adhesive strength may not be secured. When the gaps exceed 100 μm, the amount of the adhesive 5 can be excessive, and thus, contamination of products may occur due to spreading or dragging of the adhesive 5.

The surface of the adhesive discharge roller 10 may be coated with a separate material, and particularly, may be coated with rubber, such as silicone or ethylene-propylene-diene monomer, for example.

The adhesive discharge roller 10 and the composite punching roller 20 may be engaged with each other to be rotated, and may be rotated at substantially the same speed (e.g., tangential speed). The adhesive 5 of an almost constant thickness may be applied to the surface of the adhesive discharge roller 10, and the adhesive discharge roller 10 may mainly contact the punching unit 22 of the composite punching roller 20, particularly the stepped part 22c of the punching unit 22, to transfer the adhesive 5.

The membrane electrode assembly processing apparatus 100 may further include an electrode detector 25 positioned in front of (at a previous stage of) the composite punching roller 20 and configured to detect the position of the electrode layer of the membrane electrode assembly unit and to provide information to control the punching position of the composite punching roller 20.

The electrode detector 25 may include a vision camera sensor, an ultraviolet sensor, or the like, may detect the position of the electrode layer, and may provide information so that the punching unit 22 of the composite punching roller 20, particularly the punching blade 22b of the punching unit 22, is engaged with the perimeter of the membrane electrode assembly unit.

The adhesive discharge roller 10 and the composite punching roller 20 can be rotated in the order shown in FIGS. 5A to 5D to punch out the membrane electrode assembly unit from the MEA transfer film 2. For example, when the MEA transfer film 2 may be transferred so that one membrane electrode assembly unit starts to enter the composite punching roller 20, as shown in FIG. 5B, punching-out of the membrane electrode assembly unit and application of the adhesive 5 to the membrane electrode assembly unit may be simultaneously performed by engaging the punching blade 22b of the punching unit 22 of the composite punching roller 20 with the perimeter of the membrane electrode assembly unit, as shown in FIG. 5C, and thereafter, the MEA continuous film 2 may be transferred and the adhesive 5 may be supplied again to the stepped part 22c of the composite punching roller 20 from the adhesive discharge roller 10, as shown in FIG. 5D.

Referring to FIG. 3, the membrane electrode assembly processing apparatus 100 may further include a control roller 30 positioned behind (in a later stage of) the composite punching roller 20 and configured to transfer the punched membrane electrode assembly unit to another continuous film or fabric. The control roller 30 may be engaged with a heating roller related to the other continuous film or fabric to transfer the punched membrane electrode assembly unit to the other continuous film or fabric. This will be described in detail later in a membrane electrode assembly manufacturing apparatus 1000.

The membrane electrode assembly processing apparatus 100 may further include a carrier film recovery unit 35 positioned behind (in a later stage of) the control roller 30 and configured to recover the continuous film (carrier film) from which the membrane electrode assembly units were removed.

### Membrane Electrode Assembly Manufacturing Apparatus

Referring to FIG. 3, a membrane electrode assembly manufacturing apparatus 1000 according to an embodiment of the present disclosure may include the composite punching roller 20 and the control roller 30 of the membrane electrode assembly processing apparatus 100, and may include a punching roller 60 and a heating roller 40 of a subgasket processing apparatus 200.

For example, in an embodiment, the membrane electrode assembly manufacturing apparatus 1000 may include the composite punching roller 20 configured to punch out the membrane electrode assembly unit from the MEA continuous film 2 including the at least one membrane electrode assembly unit in the transfer direction and to apply the adhesive 5 to the outer peripheral area of the electrode layer of the membrane electrode assembly unit, the punching roller 60 configured to punch the SG continuous film 4 including a subgasket at selected, set, or predetermined intervals to form penetration parts, the heating roller 40 can be positioned behind (in a later stage of) the punching roller 60 and configured to heat the SG continuous film 4, and the control roller 30 can be positioned behind (in a later stage of) the composite punching roller 20 and configured to approach the heating roller 40 to engage therewith and to transfer the membrane electrode assembly unit to the outer peripheral area of one of the penetration parts of the SG continuous film 4.

The SG continuous film 4 may be unwound and supplied from an SG continuous film supplier 50.

The punching roller 60 may be provided with a separate punching unit (not shown) on the outer circumferential surface thereof, and may be rotated to form the penetration parts (reaction windows) through the SG continuous film 4 at the selected, set, or predetermined intervals in the transfer direction of the SG continuous film 4.

The membrane electrode assembly manufacturing apparatus 1000 may further include an auxiliary roller 61 at a position opposite to the punching roller 6o with the SG continuous film 4 interposed therebetween.

Approach of the control roller 30 to the heating roller 40 may be controlled by setting a time offset depending on a punching signal from the punching roller 6o, and may enable the membrane electrode assembly unit to be transferred to the outer peripheral area of the penetration part. For example, as the control roller 30 approaches the heating roller 40, the membrane electrode assembly unit on the control roller 30 may be engaged with the outer peripheral area of the penetration part of the SG continuous film 4 on the heating roller 40, and may be transferred thereto by heat from the heating roller 40.

The rotational speed of the heating roller 40 may be controlled, and the temperature of the heating roller 40 may be controlled by heating wires, induction coils, hot oil pipes, etc. provided in the heating roller 40. The surface temperature of the heating roller 40 may be 50° C. to 200° C., for example. When the temperature is lower than 50° C., the punched membrane electrode assembly unit may not be transferred to the SG continuous film 4, and when the temperature is higher than 200° C., defects may occur due to deformation of materials.

The SG continuous film 4 may include a surface protective film, and the surface protective film may be removed and recovered by a protective film recovery unit 70 positioned in front of (at a previous stage of) the heating roller 40.

The membrane electrode assembly manufacturing apparatus 1000 may further include a recovery unit 8o positioned behind (at a later stage of) the heating roller 40 and configured to wind and recover the SG continuous film 4 onto which the membrane electrode assembly units are transferred.

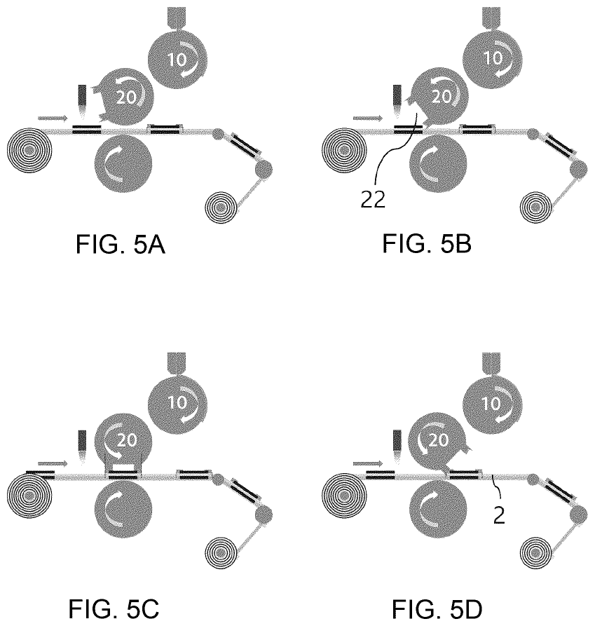

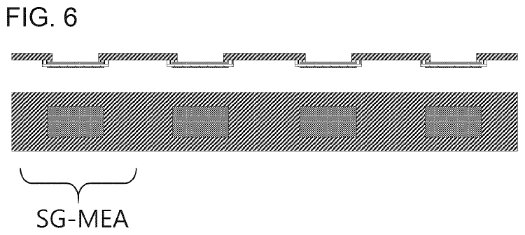

FIG. 6 shows an example form of the SG continuous film 4 onto which the membrane electrode assembly units are transferred, i.e., subgasket and membrane electrode assembly (SG-MEA) units. The SG continuous film 4 including a plurality of subgasket and membrane electrode assembly (SG-MEA) units may be obtained through the membrane electrode assembly manufacturing apparatus 1000, and a membrane electrode assembly 1 may be obtained by punching the SG continuous film 4 at appropriate intervals.

### Membrane Electrode Assembly 1

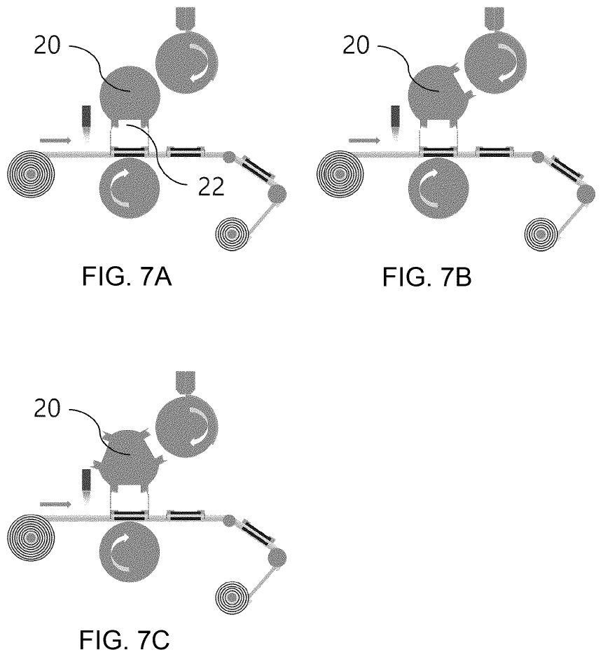

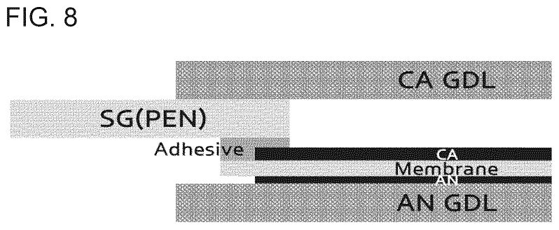

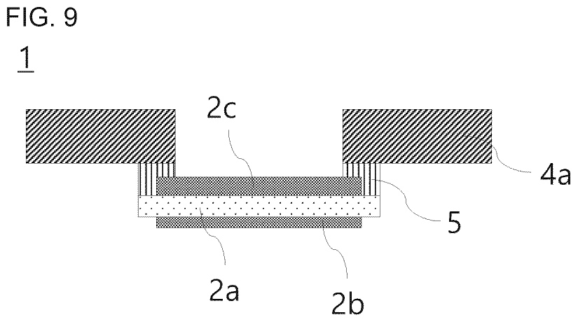

Referring to FIGS. 8 and 9, the membrane electrode assembly 1 according to an embodiment of the present disclosure may include an electrolyte membrane 2a, electrode layers 2b and 2c positioned on both surfaces of the electrolyte membrane 2a, the adhesive 5 provided to have a designated width inwards and/or outwards from the outer periphery of the surface of at least one of the electrode layers 2b and 2c, and a subgasket 4a disposed on the adhesive 5.

The subgasket 4a may be configured to not invade an area inside the adhesive 5, for example.

The electrolyte membrane 2a may include a side part extending in a plane direction perpendicular to the thickness direction thereof farther outwards than the electrode layers 2b and 2c, the adhesive 5 may be provided to have a designated width from the side part to the inside of the outer periphery of the at least one of the electrode layers 2b and 2c, and the thickness of the adhesive 5 may be greater than the thickness of the at least one of the electrode layers 2b and 2c based on the side part.

For example, the adhesive 5 of the membrane electrode assembly 1 may be provided to have the designated width inwards and/or outwards from the outer periphery of the surface of a cathode 2c. The width of the adhesive 5 may correspond to the above-described width of the adhesive 5 provided in the outer peripheral area of the electrode layer.

FIG. 8 shows one example, an assembly electrochemical gas analyzer (EGA) obtained by forming the subgasket 4a and gas diffusion layers on the membrane electrode assembly MEA. In FIG. 8, AN indicates an anode, CA indicates a cathode, AN GDL indicates a gas diffusion layer formed on the anode, and CA GDL indicates a gas diffusion layer formed on the cathode.

The membrane electrode assembly 1 can have a small non-reactive area and a relatively reduced volume, and may thus have a high power density.

The membrane electrode assembly 1 having such a structure may be implemented through the above-described membrane electrode assembly processing apparatus 100 and membrane electrode assembly manufacturing apparatus 1000, and may be manufactured through a continuous process while minimizing losses of the adhesive 5 and the electrolyte membrane 2.

As can be apparent from the above description, a membrane electrode assembly processing apparatus and a membrane electrode assembly manufacturing apparatus according to an embodiment of the present disclosure may punch out a membrane electrode assembly unit from an MEA continuous film including a plurality of membrane electrode assembly units through a composite punching roller, and may simultaneously apply an adhesive to the membrane electrode assembly unit to have a designated width inwards and/or outwards from the outer periphery of the surface of at least one of electrode layers, thereby allowing continuous and accurate bonding of the membrane electrode assembly units to a subgasket and maximizing mass production of membrane electrode assemblies.

A membrane electrode assembly processing apparatus and a membrane electrode assembly manufacturing apparatus according to an embodiment of the present disclosure may minimize deformation of materials and prevent defects due to dimensional and external deformation during processes.

A membrane electrode assembly processing apparatus and a membrane electrode assembly manufacturing apparatus according to an embodiment of the present disclosure may minimize waste and losses of an electrolyte membrane and the adhesive.

Advantages of embodiments of the present disclosure are not necessarily limited to the above-mentioned advantages. Advantages of embodiments of the present disclosure can be understood to include other advantages that may be inferred from the above description.

The present disclosure has been described in detail with reference to some embodiments thereof. However, it can be appreciated by those skilled in the art that changes may be made in these embodiments without departing from the principles and spirit of the disclosure, the scope of which can be defined in the appended claims and their equivalents.

What is claimed is:

1. A membrane electrode assembly processing apparatus comprising a composite punching roller configured to punch out a membrane electrode assembly unit from a membrane electrode assembly (MEA) continuous film comprising at least one membrane electrode assembly unit in a transfer direction and to apply an adhesive to an outer peripheral area of an electrode layer of the membrane electrode assembly unit.

2. The apparatus of claim 1, wherein the outer peripheral area of the electrode layer is configured to have a designated width inwards or outwards from an outer periphery of a surface of the electrode layer.

3. The apparatus of claim 1, wherein the MEA continuous film further comprises a carrier film adhered thereto in a direction opposite to an application direction of the adhesive, and the composite punching roller is configured to punch out the membrane electrode assembly unit except for the carrier film.

4. The apparatus of claim 1, wherein the composite punching roller comprises at least one punching unit provided on a surface thereof, and each of the at least one punching unit comprises a flat punching plate, a punching blade protruding from the punching plate to correspond to a perimeter of the membrane electrode assembly unit, and a stepped part configured to have a stepped part width and thickness in an inward direction from an inner circumference of the punching blade.

5. The apparatus of claim 4, wherein the stepped part thickness of the stepped part is 100 μm to 10 mm based on the punching plate.

6. The apparatus of claim 4, wherein a height of the punching blade is 110 μm to 11 mm based on the punching plate.

7. The apparatus of claim 4, further comprising an adhesive discharge roller positioned with a gap of 100 μm to 11 mm from the composite punching roller, wherein the stepped part and the punching blade of the composite punching roller are configured to receive the adhesive supplied from the adhesive discharge roller.

8. The apparatus of claim 7, further comprising an adhesive discharger configured to supply the adhesive, and a leveler, wherein the adhesive discharge roller is configured to receive the adhesive being supplied from the adhesive discharger on a surface of the adhesive discharge roller, and wherein the leveler is configured to adjust a thickness of the adhesive on the surface of the adhesive discharge roller.

9. The apparatus of claim 8, wherein each of a gap between the adhesive discharger and the adhesive discharge roller and a gap between the leveler and the adhesive discharge roller is 5 μm to 100 μm.

10. The apparatus of claim 1, further comprising an electrode detector positioned in ahead of the composite punching roller and configured to detect a position of the electrode layer of the membrane electrode assembly unit and to provide information to control a punching position of the composite punching roller.

11. The apparatus of claim 1, further comprising an MEA continuous film supplier configured to supply the MEA continuous film.

12. A membrane electrode assembly manufacturing apparatus comprising:
a composite punching roller configured to punch out a membrane electrode assembly unit from a membrane electrode assembly (MEA) continuous film comprising at least one membrane electrode assembly unit in a transfer direction and to apply an adhesive to an outer peripheral area of an electrode layer of the membrane electrode assembly unit;
a punching roller configured to punch an subgasket (SG) continuous film comprising a subgasket at set intervals to form penetration parts;
a heating roller positioned behind the punching roller and configured to heat the SG continuous film; and
a control roller positioned behind the composite punching roller and configured to approach the heating roller to engage therewith and to transfer the membrane electrode assembly unit to an outer peripheral area of one of the penetration parts of the SG continuous film.

13. The apparatus of claim 12, wherein a surface temperature of the heating roller is 50° C. to 200° C.

14. The apparatus of claim 12, further comprising a protective film recovery unit positioned ahead of the heating roller, wherein the SG continuous film comprises a surface protective film, and wherein the protective film recovery unit is configured to recover the surface protective film after it is removed from the SG continuous film.

15. The apparatus of claim 12, further comprising a recovery unit positioned behind the heating roller and configured to wind and recover the SG continuous film onto which the membrane electrode assembly unit is transferred.

16. A membrane electrode assembly comprising:
an electrolyte membrane;
electrode layers on both surfaces of the electrolyte membrane;
an adhesive provided to have a width inwards and/or outwards from an outer periphery of a surface of at least one of the electrode layers; and
a subgasket on the adhesive.

17. The assembly of claim 16, wherein:
the electrolyte membrane comprises a side part configured to extend in a plane direction perpendicular to a thickness direction thereof farther outwards than the electrode layers;
the adhesive is provided to have the width from the side part to an inside of the outer periphery of the at least one of the electrode layers; and
an adhesive thickness of the adhesive is greater than an electrode thickness of the at least one of the electrode layers based on the side part thereof.
